(19) United States
(12) Patent Application Publication
(10) Pub. No.: US 2012/0132510 A1
(43) Pub. Date: May 31, 2012

(54) Multi-Directional Switch Cell

(76) Inventor: Alexandru Salagean, Mississauga (CA)

(21) Appl. No.: 13/298,043

(22) Filed: Nov. 16, 2011

Related U.S. Application Data
(60) Provisional application No. 61/414,193, filed on Nov. 16, 2010.

(51) Int. Cl. H01H 3/42

(52) U.S. Cl. 200/573

(57) ABSTRACT

An electrical switch assembly is provided having a switch cell. The switch cell comprises at least one actuator assembly for actuating a switch. The actuator assembly comprises a resilient member; an actuator comprising a slot for receiving a post therethrough to guide movement of the actuator relative to a housing for the electrical switch, a first cam to engage the resilient member, a second cam, and a protrusion; and a contact providing a surface to engage the second cam; wherein a force imparted on the protrusion causes the second cam to move the contact and actuate the electrical switch.

This application claims priority from U.S. Provisional Application No. 61/414,193 filed on Nov. 16, 2010, the contents of which are incorporated herein by reference.

### TECHNICAL FIELD

The following relates generally to electrical switches and more particularly to multi-directional switch cells for such switches.

### BACKGROUND

Electrical switches are often used in automotive applications to control features in an automobile, e.g. power windows, seat adjustments, door locks, etc. It is often desirable that switches activated by a user in automotive and other applications provide a tactile feedback to enable the user to discern between different switching stages and/or functions. In this way, the user experiences changes in force during operation of the switch that provides feedback to the user as to the state of the switch.

For example, when the switch is activated, the user may first feel an increasing resistive force, and then a drop in force as the actuator stops in a discernible position that indicates to the user that the switch is electrically activated. This discernible position is often referred to as the detent. The switch may also provide a similar detent when moving the actuator in the opposite direction. Some switches are four-directional or “4-way”, providing bi-directional sliding or rotating/pivoting actions along a pair of typically orthogonal axes.

Two basic designs are prevalent for providing such tactile feedback, one is a spring-based resilient member, and the other is a silicone rubber based membrane or elastomeric pad, often referred to as an “e-pad”, which provides tactile response and electrical switching when interfaced with a printed circuit board (PCB). Whether a spring-based member or an e-pad is used, the chosen approach often needs to address some packaging and component count constraints of the product. In automotive applications, many switches are multi-functional and the differentiation between the functions is often also important. In addition to these considerations, the space available for the components of the switches may be limited and thus a lower profile is usually desirable, as well as fewer components. Despite these considerations, often both of these design choices may suffer from limitations in force, travel, package size, and performance variations.

### SUMMARY

In one aspect, there is provided an actuator assembly for an electrical switch, the assembly comprising: a resilient member; an actuator comprising a slot for receiving a post therethrough to guide movement of the actuator relative to a housing for the electrical switch, a first cam to engage the resilient member, a second cam, and a protrusion; and a contact providing a surface to engage the second cam; wherein a force imparted on the protrusion causes the second cam to move the contact and actuate the electrical switch.

In another aspect, there is provided a switch cell comprising at least one actuator assembly for operating an electrical switch, each actuator assembly comprising: a resilient member; an actuator comprising a slot for receiving a post therethrough to guide movement of the actuator relative to a housing for the electrical switch, a first cam to engage the resilient member, a second cam, and a protrusion; and a contact providing a surface to engage the second cam; wherein a force imparted on the protrusion causes the second cam to move the contact and actuate the electrical switch.

In yet another aspect, there is provided an electrical switch comprising an actuation knob supported on a housing, the housing containing at least one switch cell according to the above.

In some embodiments, two actuator assemblies may be used to provide bi-directional movement and in other embodiments, four actuator assemblies may be used to provide 4-directional movement. Electrical switch assemblies such as those used in automobile applications may also be provided having at least one switch cell as described above.

### BRIEF DESCRIPTION OF THE DRAWINGS

Embodiments will now be described by way of example only with reference to the appended drawings wherein:

FIG. 1 is a pictorial view of an electrical switch assembly used in an automobile.

FIG. 2 is a perspective view of an example electrical switch cell from above.

FIG. 3 is a perspective view of the electrical switch cell of FIG. 2 from below.

FIG. 4 is a perspective view of the interior of the electrical switch cell of FIG. 2.

FIG. 5 is a plan view of the interior of the electrical switch cell of FIG. 2.

FIG. 6 is an exploded perspective view of the electrical switch cell of FIG. 2.

FIG. 7 is a partial perspective view of an actuator of the electrical switch cell of FIG. 2 in isolation and various components thereof in isolation.

FIG. 8 is a partial perspective view of an actuator of the electrical switch cell of FIG. 2.

FIG. 9 is an enlarged partial plan view of a central portion of the interior of the electrical switch cell of FIG. 2.

FIGS. 10 to 14 are partial plan views of an actuator of the electrical switch cell of FIG. 2 illustrating operation thereof.

FIG. 15 provides a series of views of the electrical switch cell of FIG. 2 illustrating example proportions and dimensions thereof.

FIG. 16 is an example force/displacement curve for the actuator of the electrical switch cell of FIG. 2.

### DETAILED DESCRIPTION OF THE DRAWINGS

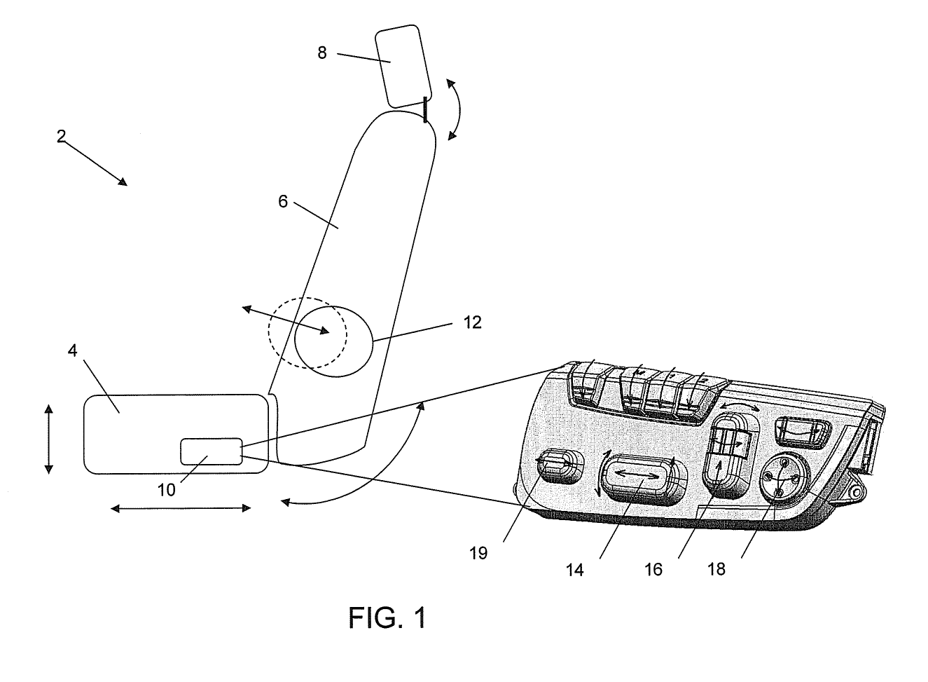

Referring now to FIG. 1, an automobile seat 2 is shown having a bench 4, backrest 6, and headrest 8. The backrest 6 comprises a lumbar member 12. The bench 4 includes a switch panel 10 comprising a number of switches 14, 16, 18, 19 as shown in a partial enlarged view. The switches 14, 16, 18, 19 include actuation knobs or buttons, which may be operated by a user to control the positioning of respective components of the seat 2. As illustrated by the arrows, each switch 14, 16, 18, 19 permits a particular number of directional movements and some may permit bi-directional sliding or pivoting movements along a particular axis while others permit 4-directional sliding or pivoting movements. It has been found that the greater the number of functions operated by a particular switch, the more difficult it becomes to provide both tactile mechanisms to provide the requisite “feel” to the switch while maintaining a relatively low profile. Furthermore, the greater the number of functions typically translates into relatively complicated designs with a great number of components. The greater the number of components and the greater complexity typically increases the cost of the switch which is undesirable.

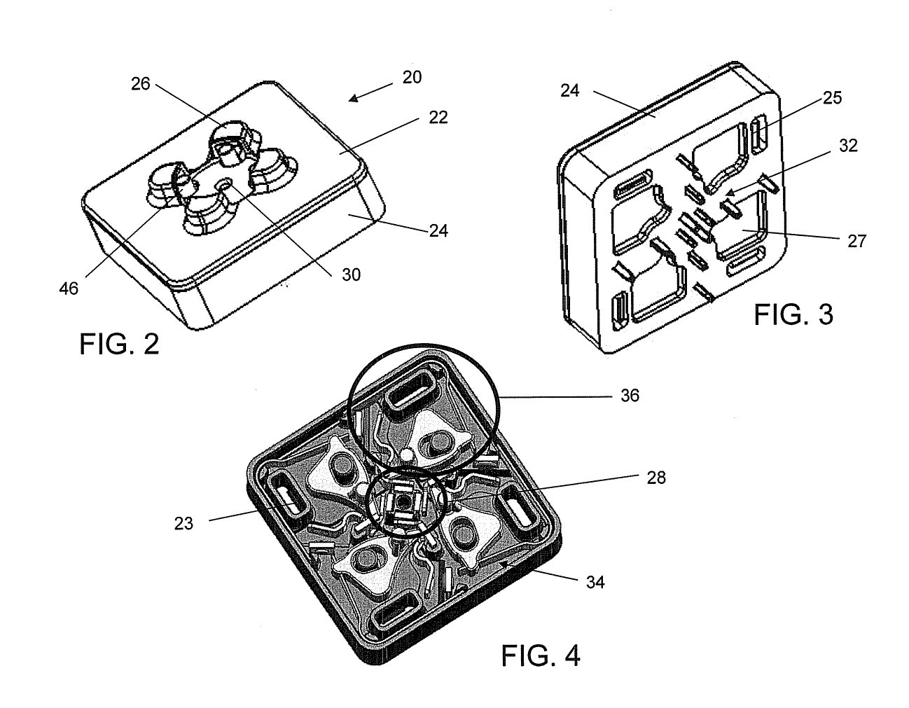

To provide bi-directional or 4-way switches such as those shown in FIG. 1, it has been recognized that multiple cam and spring mechanisms can be integrated into a relatively flat package within minimal components by incorporating horizontally sliding and rotating actuator assemblies 36 acting between a spring 34 or other resilient member, and respective profiled contacts 42 as shown in FIGS. 2 through 9.

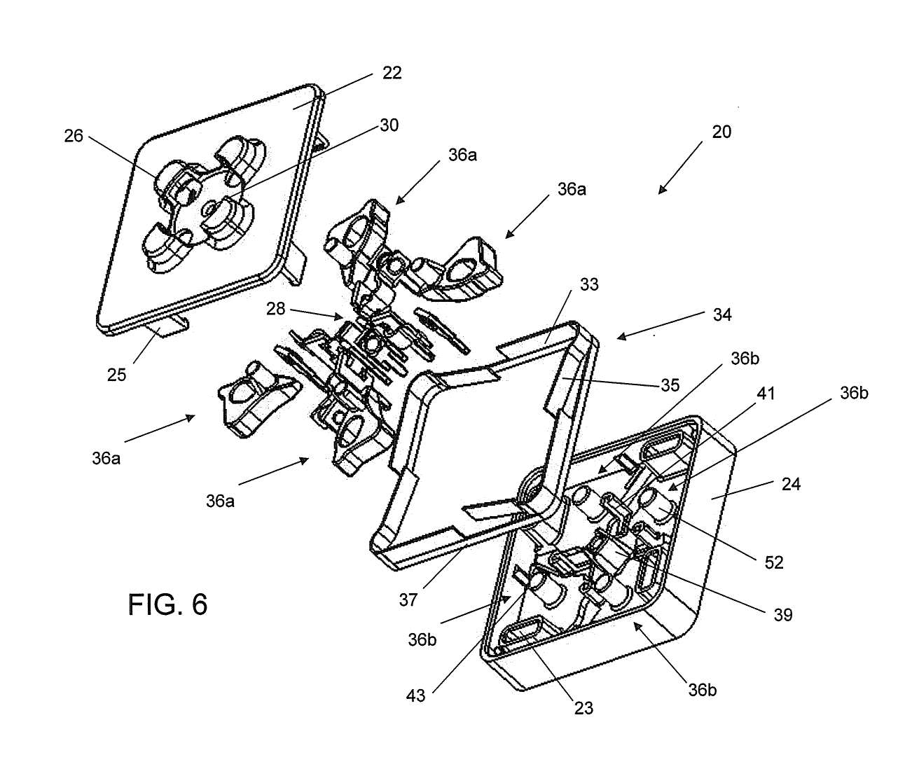

Turning now to FIGS. 2 and 3, a switch cell 20 is shown, which may be integrated or otherwise used in an electrical switch, e.g., those shown in FIG. 1. It can be appreciated that an actuation button and housing of the electrical switch may be configured to accommodate one or more of the switch cells 20 in order to enable an actuation button to operate on the switch cell 20 as discussed below. It can also be appreciated that equivalent components and functionality may also be integrated directly into the electrical switch. The switch cell 20 comprises an upper housing 22 and a lower housing 24 which fit together using complementary slots 23 and tabs 25, the slots 23 being integrated into the lower housing 24 as shown in FIG. 4 and the tabs 25 being integrated into the upper housing 22 as best seen in FIG. 6. The upper housing 22 comprises a set of hoods 26 formed therein, each hood 26 providing a passage into the interior of the lower housing 24 to expose an actuator post 46 of a corresponding actuator assembly 36. The actuator posts 46 are exposed to enable an actuation button (not shown) to impart a force thereon to actuate the corresponding switch. It can be appreciated that the nature and configuration of the button or knob will vary according to the application. In the example shown in FIG. 2, a central mounting point 30 is provided to enable a 4-way switch button to be mounted on the upper housing 22 in a position suitable for translating movements thereof to actuation of respective switch functions.

As best seen in FIG. 3, the lower housing 24 comprises a number of passages (not shown) that permit portions of a series of contacts 32 to protrude therethrough. The contacts 32 may then be connected, e.g. by soldering or laser welding to, for example, a printed circuit board (PCB). The contacts 32 are referred to collectively at this point for ease of explanation and, as will be discussed below, this example comprises 3 different types of contacts. The lower housing 24 also comprises four embossed portions 27 which each provide a sliding surface for respective actuator assemblies 36.

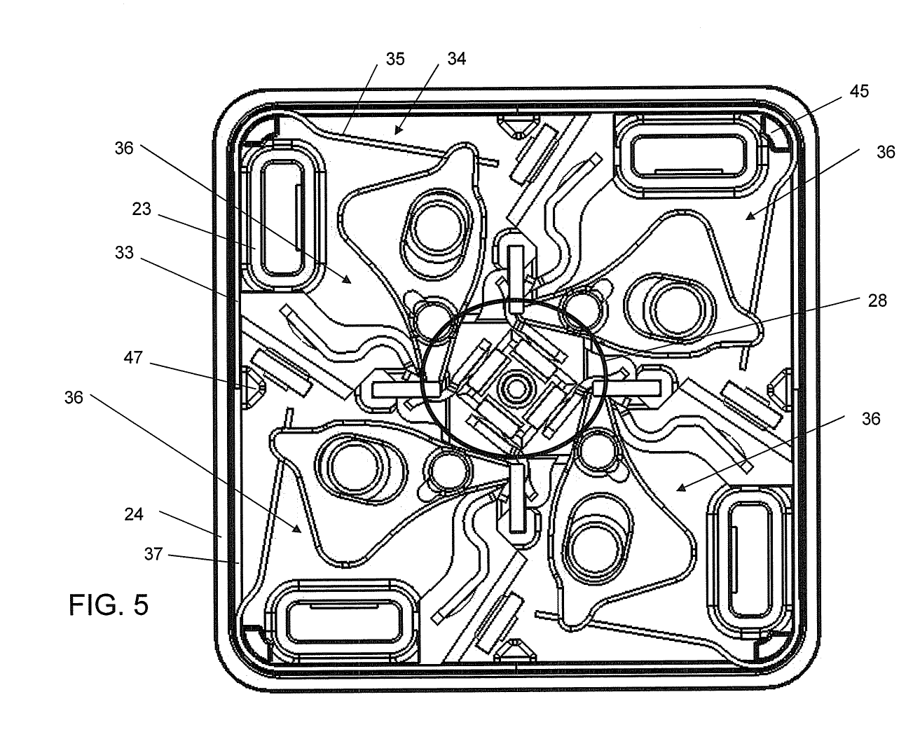

FIGS. 4 and 5 illustrate that the lower housing 24 is arranged to contain a set of four actuator assemblies 36 spaced about a central portion 28 which, as will be explained below, provides a central ground-terminal mounting area. In this example, the four actuator assemblies 36 are served by a common resilient member, in this example, spring 34. The spring 34 is best seen in the exploded view of FIG. 6. The spring 34 in this example is formed from a single band of metal that comprises a circumferentially extending lower band 37 and a resilient tab 35 cut out from an upper band thus defining four resilient tabs 35 and corresponding fixed bands 33. The fixed bands 33 are integrally formed with the lower band 37 to provide a unitary member. The spring 34 is sized to follow the periphery of the interior of the lower housing 24 as shown in FIG. 5. A set of corner supports 45 and a set of “mid-run” supports 47 secure the spring 34 within the lower housing 24 and maintain rigidity of the fixed bands 33 relative to the resilient tabs 35 to allow the resilient tabs 35 to urge towards the interior of the lower housing 24 and are therefore normally biased inwardly to impart a resilient force on the actuators 40.

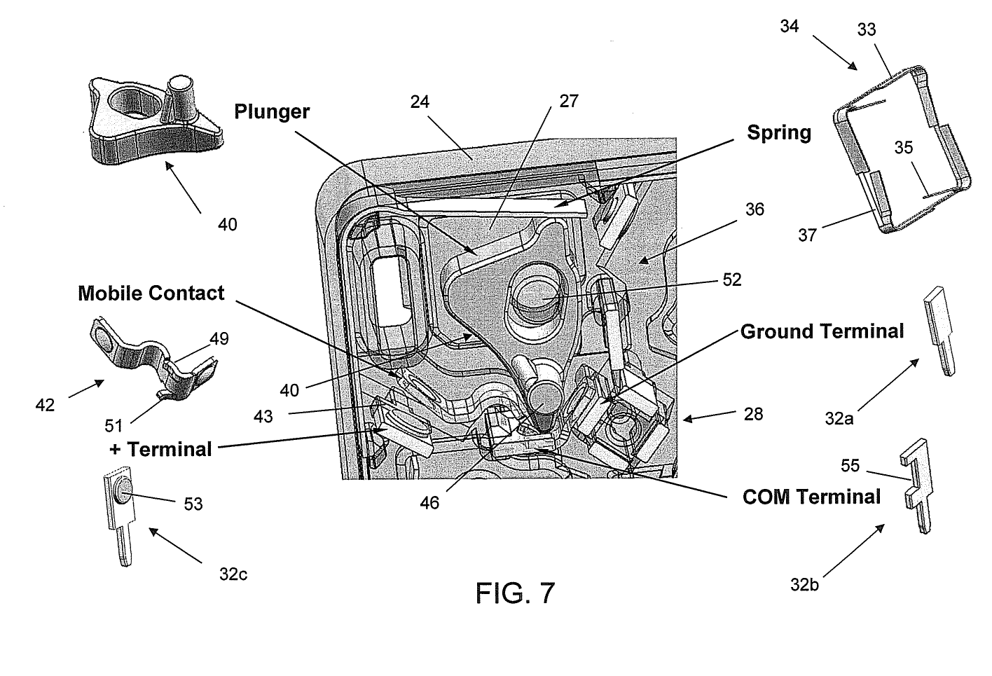

Turning again to FIG. 6, the lower housing 24 comprises a set of guide posts 52 that guide the actuators 40 of the actuator assemblies 36 in both sliding and rotating motions as explained in greater detail below. The lower housing 24 also comprises a central slotted post 39 having four slots, each for supporting a corresponding ground terminal 32a (see also FIG. 7); four terminal supports 41, each being radially spaced from the slotted post 39 and for supporting a corresponding common (COM) terminal 32b; and four slots 43 in the base of the lower housing 24 for supporting corresponding positive (+) terminals 32c.

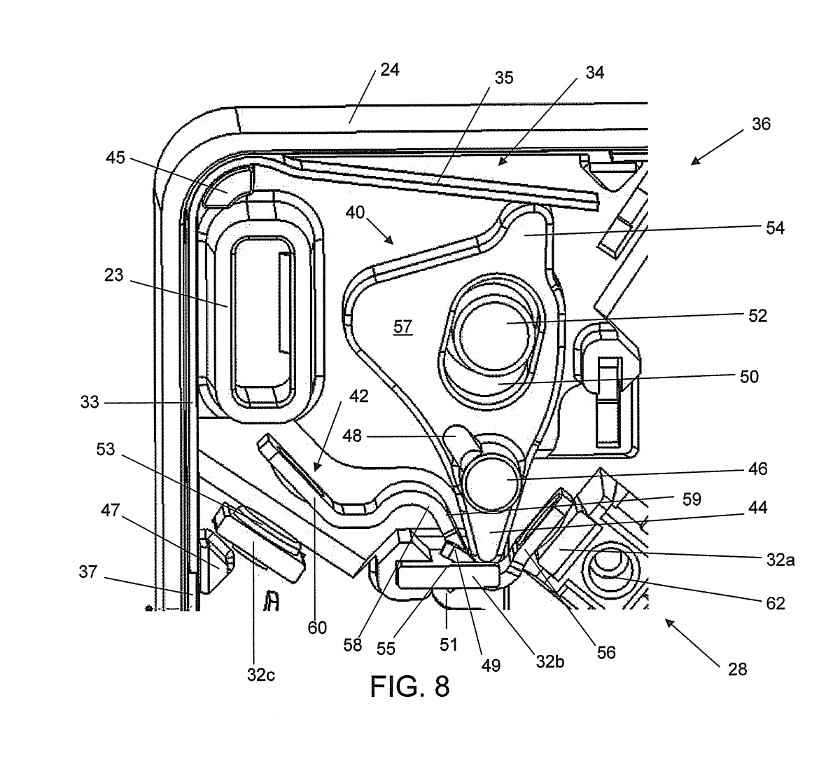

To assemble the switch cell 20, as best shown in FIGS. 6 and 7, the spring 34 is rigidly mounted in the lower housing 24 by sliding the lower band 37 around the corner and mid-run supports 45, 47. The ground terminals 32a may then be fixed in the slotted post 39 thereby assembling the central portion 28. Each actuator assembly 36 is then assembled by sliding the COM terminals 32b into the terminal supports 4a, sliding the positive terminals 32c into the slots 43, and arranging the profiled contacts 42 to pivot about the COM terminals 32b as best seen in FIGS. 7 and 8. The profiled contact 42 is profiled to have a ground end 56 that is generally planar and carries a contact for engaging a respective ground terminal 32a. The ground end 56 extends towards a positive end 60 through an S-shaped central portion 58 that provides a ramped surface 59. The central portion 58 comprises an upper tine 49 and a lower tine 51 that diverge to create a V-shaped channel. The tines 49, 51 are spaced along the middle portion 58 to align with a notch 55 in the respective COM terminal 32b (see FIG. 7). When seated as such, the upper tine 49 extends over the inner-facing surface of the COM terminal 32b and the lower tine 51 extends over the outer-facing surface of the COM terminal 32b to thus create a pivot point for the profiled contact 42 to tilt about the COM terminal 32b whilst maintaining electrical connectivity therewith.

As best seen in FIG. 8, the actuator 40 comprises a first or outer cam 54 for engaging a respective resilient tab 35 and a second or inner cam 44 for engaging a respective profiled contact 42. A slot 50 is formed in the actuator 40 between the cams 44, 54 with the actuator post 46 protruding from an upper surface at a point between the slot 50 and the inner cam 44. In this way, a force imparted on the actuator post 46 causes the actuator 40 to translate with respect to the post 52, rotate about the post 52, or both as explained in greater detail below. The actuator 40 in this example comprises an eccentric shape to thereby provide a relatively large surface 57 (on both sides) to increase the stability of the actuator 40 as it moves over its respective embossed portion 27. The actuator 40 may be added to the actuator assembly 36 by fitting the slot 50 over its respective guide post 52 such that its respective actuator post 46 extends in an upward direction. This may be done by urging the outer cam 54 against the resilient tab 35 to allow the actuator 40 to engage the underlying embossed portion 27. The resilience provides by the tab 35 then urges the actuator 40 back towards the profiled contact 42 to thereby allow the inner cam 44 to seat against the ramped surface 59 at the bottom end of the middle portion 58 towards the ground end 56 as shown in FIG. 8. In the rest position, the slot 50 guides inner cam 44 towards the bottom of the S-shape under the influence of the tab 35 to cause the contact 42 to pivot about the notch 55 thus urging the ground end 56 into electrical contact with the ground terminal 32a. When installed, each actuator 40 is slidable over its respective embossed portion 27 by imparting a force on the actuator post 46. As will be explained below, the interaction of the inner cam 44 and the ramped surface 59 causes the contact 42 to begin tilting about the notch 55 at a particular point to provide a “snap-over” or discernible detent causing the positive end 60 to engage a contact 53 on the positive terminal 32c. It may be noted that in some embodiments, such as high-current applications, the contact 53 may be chosen to include a material that is more durable such as a silver-plated copper contact.

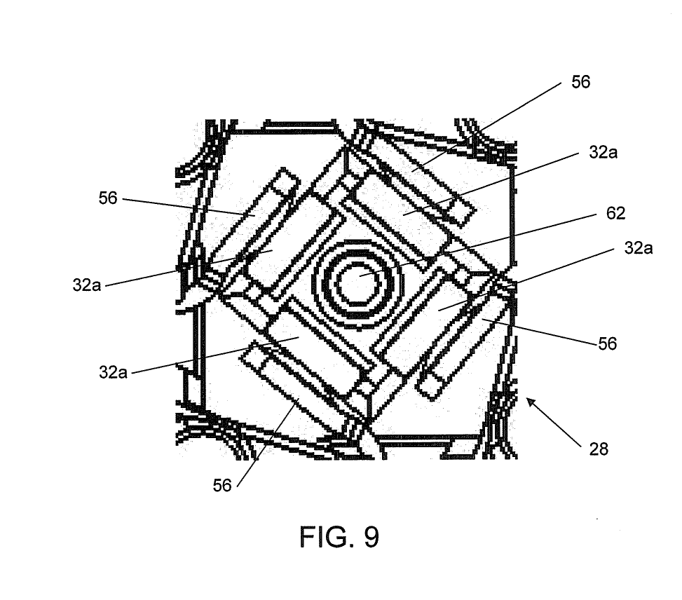

With all actuator assemblies 36 installed as shown in FIG. 5, all ground ends 56 of the profiled contacts 42 are in engagement with their respective ground terminals 32a as illustrated in the enlarged view of the central portion 28 of FIG. 9. Each actuator post 46 is exposed through a respective hood 26 as seen in FIG. 2 and upon moving an actuator knob towards one of the actuator posts 46 a respective switch function is controlled.

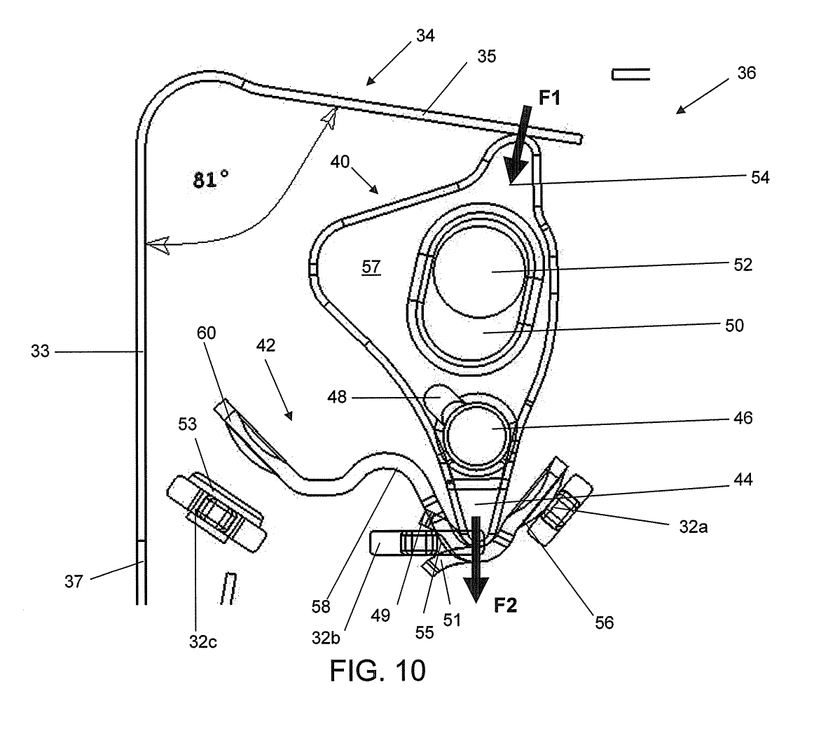

Turning now to FIGS. 10 to 14, operation of one of the actuator assemblies 36 is shown. It can be appreciated that all of the actuator assemblies 36 operate in a similar manner and thus only operation of one is needed to demonstrate the principles herein.

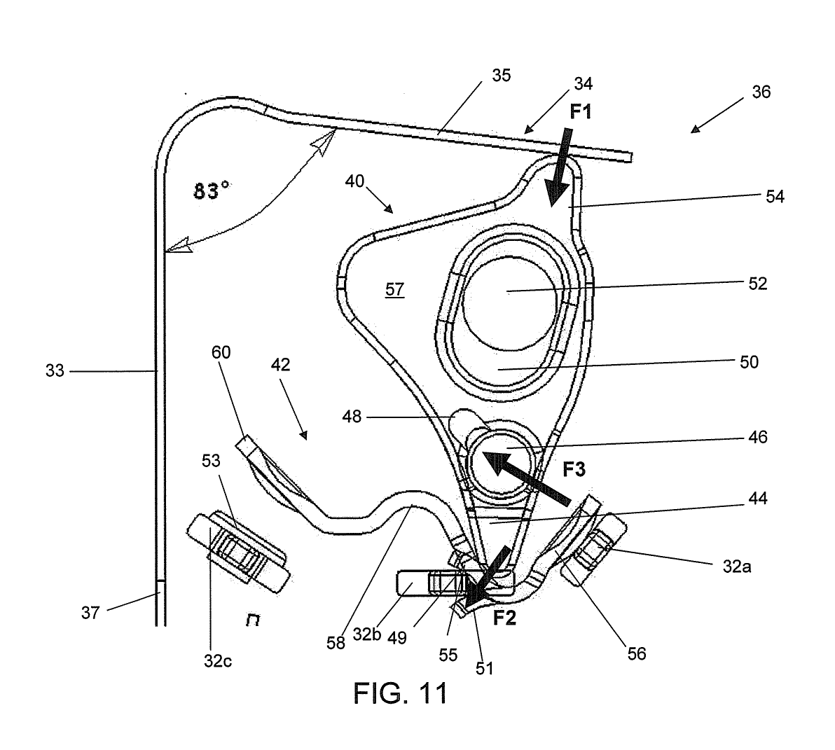

FIG. 10 shows the at rest position wherein a first force F1 urges the actuator 40 towards the contact 42. The inner cam 44 in turn imparts a second force F2 on the contact 42 which retains the actuator 40 in place to minimize rattling and to maintain contact between the ground end 56 and the ground terminal 32a. In this example the tab 35 defines an angle of approximately 81 degrees with respect to the fixed band 33 for illustrative purposes only. As such, it can be appreciated that in other configurations or applications a different angle may be seen at rest. FIG. 11 illustrates that as a third force F3 acts upon the actuator post 46 (in the direction shown), the actuator 40 begins to translate by allowing the guide post 52 to slide within the slot 50. The translation occurs due to the interaction between the inner cam 44 and the ramped surface 59. Since the normal force of F2 is still in advance of the pivot point provided by the notch 55, the profiled contact 42 does not move thus maintaining contact between the ground end 56 and the ground terminal 32a as the actuator travel begins. In this example, an angle of 83 degrees is shown illustrating that the first force F1 will begin to increase as the tab 35 is urged away from its rest position.

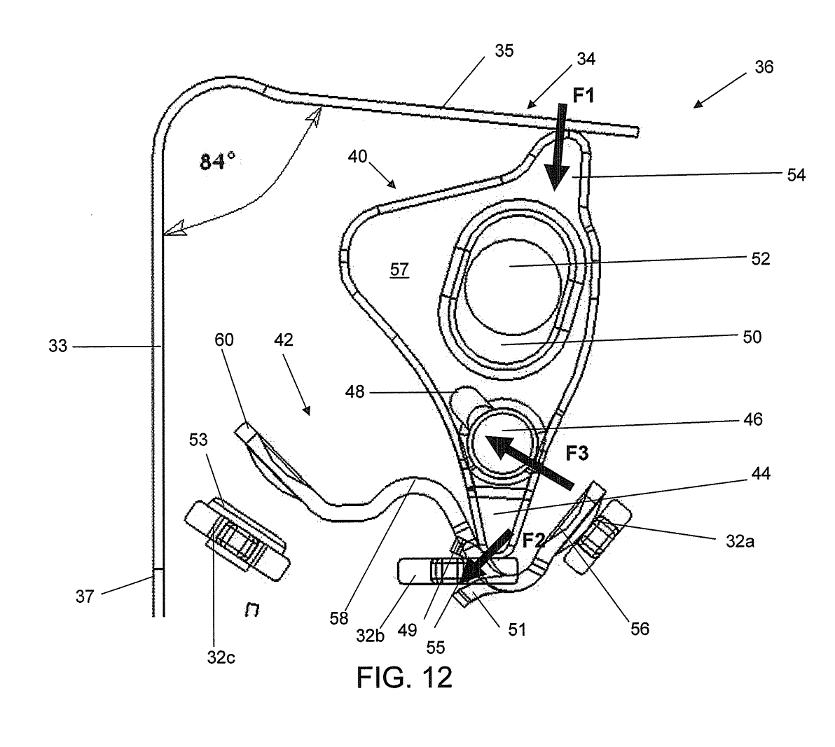

Turning now to FIG. 12, by observing the relative positioning of the post 52 and the slot 50 when compared to the position shown in FIG. 11, it can be seen that the actuator 40 continues to translate towards the tab 35 thus increasing the angle between it and the fixed band 33 to approximately 83 degrees and increasing the force F1. By also observing the position of the inner cam 44 when compared to FIG. 11, it can also be seen that the inner cam 44 continues to slide up the ramped surface 49 thus moving the normal force F2 closer to the pivot point provided by the notch 55. Since the normal force F2 is still in advance of the pivot point, the ground end 56 maintains contact with the ground terminal 32a.

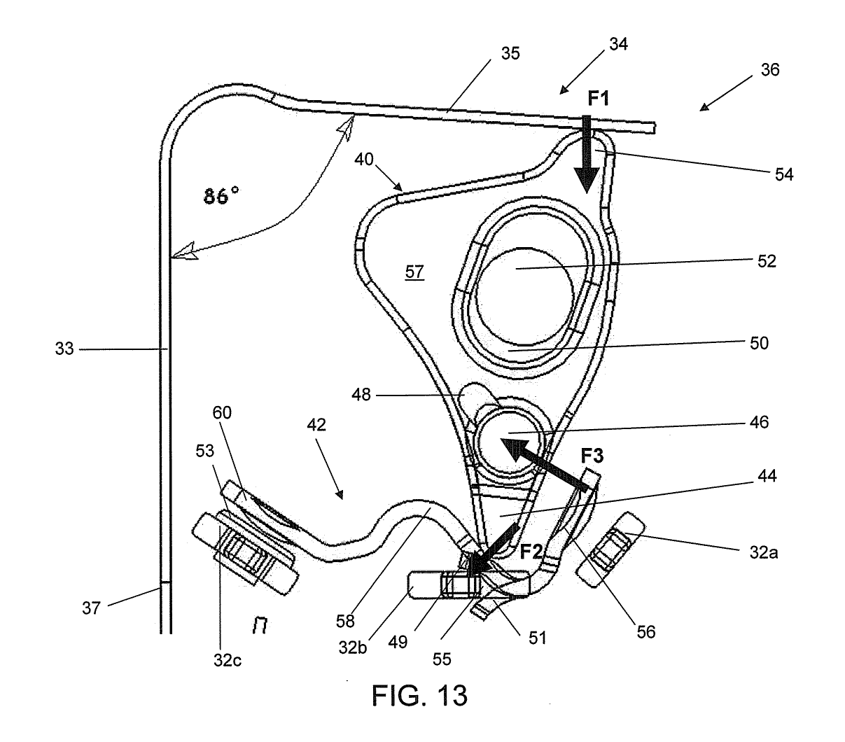

FIG. 13 illustrates a next stage in the switching operation wherein the snap over or detent is felt and the positive end 60 engages the positive terminal 32c. By again comparing the positioning of the pin 52 with respect to the slot 50 and the inner cam 44 to the corresponding components in FIG. 12, it can be seen that the normal force F2 now passes the pivot point provided by the notch 55 and the profiled contact 42 pivots about the pivot point urging the positive end 60 into engagement with the contact 53 of the positive terminal 32c. During the pivoting motion, the contact 42 maintains contact with the COM terminal 32b due to the interaction of tines 49, 51 and the notch 55. The tines 49, 51 also retain the profiled contact 42 during movement thereof. In the position shown in FIG. 13, the tab 35 has been urged further outward creating an angle of 86 degrees in this example. It can be appreciated that as the actuator 40 continues to slide outwardly, it will begin to slightly rotate about the pin 50 due to a torque created by the first force F1 as this force is redirected away from the fixed band 33.

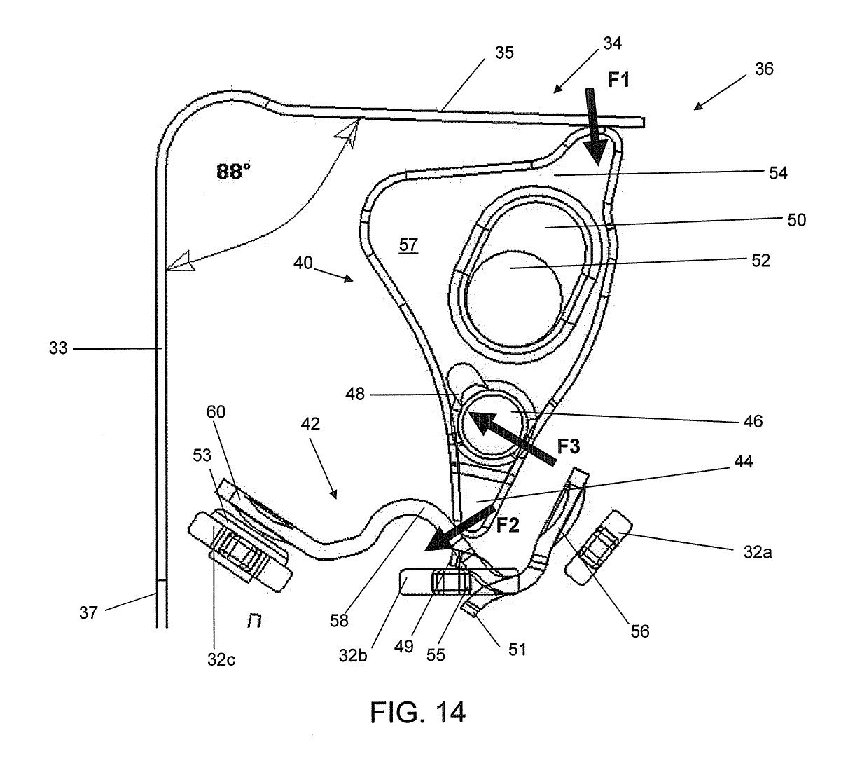

At the point shown in FIG. 13, electrical contact has been made with the positive terminal 32c thus operating the associated switching function. Turning to FIG. 14, it can be seen that further application of the third force F3 effectively locks the actuator 40 between the contact 42 and the tab 35 due to the shape of the ramped surface 59 and the first force F1. It can be seen that continued movement may occur, e.g. until the tab 35 is approximately 88 degrees relative to the fixed band 33, which is sometimes referred to as an “over-travel” condition. In such a condition, slight deformation of the components may occur however the actuator 40 will feel as if it has stopped.

Upon releasing the switch by removing the third force F3, it can be appreciated that due to the first force F1 imparted by the tab 35, the actuator 40 slides back on the ramped surface 59 in a reverse sequence, maintaining the engagement of the profiled contact 42 and the positive terminal 32b, until the inner cam 44 passes over the pivot point created by the notch 55. At this point, the S-shaped middle portion 58 and its tines 49, 51 return to the rest position wherein the ground end 56 makes contact with the ground terminal 32a.

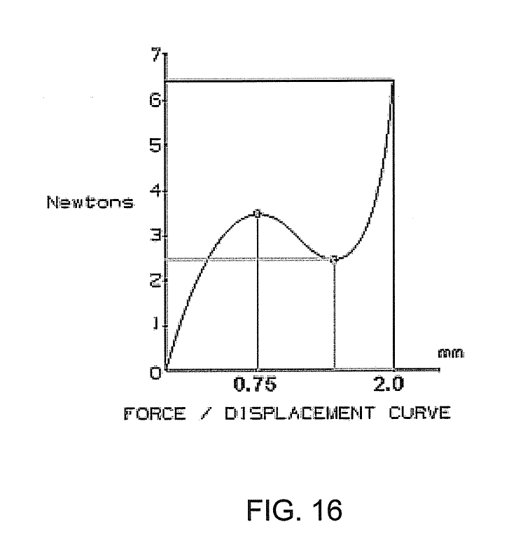

It can be appreciated that to achieve a common force/displacement curve such as that shown in FIG. 16, the angle of the ramped surface 59, the shape of the inner and outer cams 44, 54, and the resilience of the tab 35 can be adjusted. In the example shown herein, the snap over point occurs at approximately 3.5N of force and 0.75 mm of travel with electrical contact being made with approximately 2.5N of force and approximately 1.5 mm.

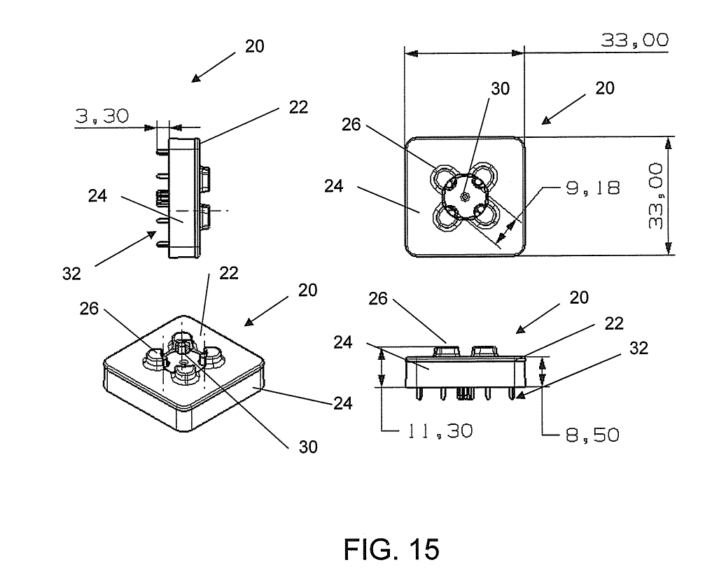

By aligning the actuator assemblies 36 in a relatively horizontal position, and the actuation movements are radially directed, as shown in FIG. 5, a relatively low profile of approximately 11.3 mm can be achieved as shown in FIG. 15 in a 33×33 mm package.

The actuator 40 may also be used with other types of contacts and the principles described above with respect to operation of the actuator should not be considered limited to use with a pivotal contact 42. For example, an actuator assembly 36 may be configured such that a force imparted on the protrusion 46 causes the actuator 40, under the effect of resilience provided by a resilient member, to operate a sliding contact (not shown). It can be appreciated therefore that the actuator 40 may be included in various actuator assemblies 36 to provide a relatively low profile packaging.

Although the above principles have been described with reference to certain specific embodiments, various modifications thereof will be apparent to those skilled in the art without departing from the scope of the claims appended hereto.

1. An actuator assembly for an electrical switch, the assembly comprising:
a resilient member;
an actuator comprising a slot for receiving a post therethrough to guide movement of the actuator relative to a housing for the electrical switch, a first cam to engage the resilient member, a second cam, and a protrusion; and
a contact providing a surface to engage the second cam;
wherein a force imparted on the protrusion causes the second cam to move the contact and actuate the electrical switch.

2. The actuator assembly of claim 1, the contact being pivotal about a pivot point, wherein movement of the second cam causes a pivotal movement of the contact from a first position to a second position.

3. The actuator assembly of claim 2, wherein the pivot point is provided by a common terminal, and wherein a first end of the contact engages a ground terminal in the first position and a second end of the contact engages a positive terminal in the second position.

4. The actuator assembly of claim 2, wherein the contact comprises a ramped surface on which the second cam travels to cause the pivotal movement of the contact.

5. The actuator assembly of claim 4, wherein an S-shaped portion of the contact comprises the ramped surface, wherein the force imparted on the protrusion causes the second cam to travel up the ramped surface against a force imparted by the resilient member on the first cam, until pivoting the contact to move from the first position to the second position.

6. The actuator assembly of claim 5, wherein the pivot point is provided by a common terminal, and wherein a first end of the contact engages a ground terminal in the first position and a second end of the contact engages a positive terminal in the second position.

7. The actuator assembly of claim 1, wherein the protrusion extends upwardly through the housing of the electrical switch to provide an exposed portion to be acted upon by an actuation knob.

8. The actuator assembly of claim 1, wherein the slot is rounded at each end to accommodate a rounded profile of the post.

9. A switch cell comprising at least one actuator assembly for operating an electrical switch, each actuator assembly comprising:
a resilient member;
an actuator comprising a slot for receiving a post therethrough to guide movement of the actuator relative to a housing for the electrical switch, a first cam to engage the resilient member, a second cam, and a protrusion; and
a contact providing a surface to engage the second cam;
wherein a force imparted on the protrusion causes the second cam to move the contact and actuate the electrical switch.

10. The switch cell of claim 9, the contact being pivotal about a pivot point, wherein movement of the second cam causes a pivotal movement of the contact from a first position to a second position.

11. The switch cell of claim 10, wherein the pivot point is provided by a common terminal, and wherein a first end of the contact engages a ground terminal in the first position and a second end of the contact engages a positive terminal in the second position.

12. The switch cell of claim 10, wherein the contact comprises a ramped surface on which the second cam travels to cause the pivotal movement of the contact.

13. The switch cell of claim 12, wherein an S-shaped portion of the contact comprises the ramped surface, wherein the force imparted on the protrusion causes the second cam to travel up the ramped surface against a force imparted by the resilient member on the first cam, until pivoting the contact to move from the first position to the second position.

14. The switch cell of claim 13, wherein the pivot point is provided by a common terminal, and wherein a first end of the contact engages a ground terminal in the first position and a second end of the contact engages a positive terminal in the second position.

15. The switch cell of claim 9, wherein the protrusion extends upwardly through the housing of the electrical switch to provide an exposed portion to be acted upon by an actuation knob.

16. The switch cell of claim 9, wherein the slot is rounded at each end to accommodate a rounded profile of the post.

17. The switch cell of claim 9, comprising at least two actuator assemblies.

18. The switch cell of claim 17, comprising four actuator assemblies.

19. The switch cell of claim 17, wherein the protrusion of each actuator is positioned about a central portion of the switch cell to enable a single actuation knob of the electrical switch to act upon each protrusion in a respective direction.

20. An electrical switch comprising an actuation knob supported on a housing, the housing containing at least one switch cell according to claim 9.
